(19) United States
(12) Patent Application Publication
(10) Pub. No.: US 2001/0030081 A1
(43) Pub. Date: Oct. 18, 2001

(54) Ladder unit for climbing up and down construction machine

(76) Inventors: Kazuyoshi Morimoto, Hirakata-shi (JP); Kou Nagaoka, Hirakata-shi (JP)

Correspondence Address: VARNDELL & VARDELL, PLLC, 106-A South Columbus Street, Alexandria, VA, 22314, US

(21) Appl. No.: 09/739,316

(22) Filed: Dec. 19, 2000

(30) Foreign Application Priority Data
Dec. 20, 1999 (JP) 1999-361284

(51) Int. Cl. E06C 9/00; B60R 3/00; E06C 5/00

(52) U.S. Cl. 182/85; 182/93; 182/127; 280/166

(57) ABSTRACT

A ladder unit for climbing up and down a construction machine, capable of stabilizing a ladder in a position of descent thereof and that of storage thereof, facilitating an operator's actions to climb up and down the construction machine, and preventing the ladder from projecting toward circumferential parts and being thereby broken. Mechanisms for locking the ladder in the position of descent thereof are provided. The ladder locking force of these locking mechanisms is rendered releasable from the ladder in a position on the construction machine. Mechanisms for locking the ladder in its storage position are also provided.

### BACKGROUND OF THE INVENTION

1. Field of the Invention

This invention relates to a ladder unit for climbing up and down a construction machine, such as a large-sized hydraulic excavator.

2. Description of the Related Art

First, a related art hydraulic excavator will be described with reference to FIGS. 1-3 which show a mode of embodiment of the present invention as well. The hydraulic excavator is provided with a lower traveling unit 1, an upper body 2 supported swingably on the lower traveling unit 1, and a working machine 3 including a boom fixed pivotably to the upper body 2, an arm and a bucket, and a cabin 4 is provided on the upper body 2. When the hydraulic excavator is large-sized, a ladder unit A is used to be climbed up and down into and out of the operator's cabin 4. This ladder unit A for climbing up and down the hydraulic excavator is fixed to the portion of a body frame 5 which is at a side portion of the upper body 2.

The related art ladder units for climbing up and down a construction machine include a ladder unit disclosed in, for example, Japanese Utility Model Laid-Open No. 4649/1985. This ladder unit for climbing up and down a construction machine will be described with reference to FIG. 4 which shows a mode of embodiment of the present invention as well. This ladder unit A is provided with a guide 10 fixed to the body frame 5, and a ladder 11 supported slidably on this guide 10. As shown in FIGS. 1 and 3, the guide 10 has a pair of, i.e. left and right guide members 12, 12 arranged in a mutually parallel condition. Each guide member 12 is provided with a ladder slider 13, and a balance weight slider 14 formed on a rear portion of the ladder slider. The ladder 11 is provided slidably on the ladder sliders, and a balance weight 15 slidably on the balance weight sliders 14. The ladder 11 and balance weight 15 are connected together by a rope 16, an intermediate portion of which is passed around a sheave 17 supported rotatably via a shaft on top portions of the upper guides 12.

An operator on the ground pulls down the ladder 11 to a position of descent of the ladder as shown in FIG. 4B, climbs up onto a catwalk 6 of the upper body 2 by using this ladder, and then gets on the cabin 4 via a stairway 7. The ladder is also used in a similar manner when, on the contrary, the operator climbs down from the upper body 2.

In the above-described related art ladder unit for climbing up and down a construction machine, the ladder 11 is always urged by the balance weight 15 so that the ladder is in a storage position thereof but the ladder is not in a locked state, in which a movement of the ladder is stopped, in the position of storage of the ladder and that of descent thereof. Therefore, even when the ladder 11 is pulled down to the position of descent thereof for the operator who is going to climb up the construction machine, the position of the ladder 11 is not stabilized, so that the operator's actions to climb up and down the construction machine cannot be made smoothly. The ladder 11 which ought to be in the position of storage thereof projects outward unexpectedly during an operation of the construction machine, and interferes with some other part to cause the ladder to be broken in some cases. Furthermore, since the related art ladder unit is fixed to the body frame with the ladder projecting outward from a side surface of the construction machine, the ladder interferes with some other part of the construction machine during an operation thereof, so that the ladder is liable to be broken.

### SUMMARY OF THE INVENTION

The present invention has been made in view of the above-mentioned circumstances, and provides a ladder unit for climbing up and down a construction machine, capable of stabilizing a ladder in a position of descent thereof to which the ladder is lowered, and facilitating an operator's actions to get on and off the ladder, and also a ladder unit for climbing up and down a construction machine, capable of preventing a ladder from projecting outward toward the surroundings and interfering with surrounding parts, and capable of solving a problem of the occurrence of breakage of the ladder ascribed to the outward projection of the ladder and the interference thereof with the mentioned parts.

According to an aspect of the present invention, the ladder unit for climbing up and down a construction machine has a guide 10 provided on a body frame 5, and a ladder 11 supported longitudinally slidably on the guide 10 and adapted to be moved up and down between a storage position in which the ladder is stored and a position of descent to which the ladder is lowered during the use thereof, the ladder unit being further provided with a locking mechanism 52 adapted to lock the ladder 11 in the position of descent thereof.

In this ladder unit for climbing up and down a construction machine, a movement of the ladder 11 is stopped by the locking mechanism 52 in the position of descent to which the ladder is lowered. Therefore, the ladder 11 is stabilized in this position of descent, so that the operator's actions to get on and off the ladder can be made smoothly.

According to another aspect of the present invention, the ladder unit for climbing up and down a construction machine has the locking mechanism 52 capable of releasing on the construction machine a ladder from a locking force of the locking mechanism.

In this ladder unit for climbing up and down a construction machine, a locking operation of the locking mechanism 52 can be stopped, for example, from a position on a catwalk after an operator has climbed up to the catwalk. Therefore, an operation for storing the ladder 11 in a storage position can be carried out easily. For example, when the ladder 11 is adapted to be returned naturally to the storage position by using a balance weight 15, the ladder 11 is restored as it is to the storage position by the above-mentioned ladder unlocking operation, whereby the degree of convenience of use of the ladder is improved.

According to still another aspect of the present invention, the ladder unit for climbing up and down a construction machine has a locking mechanism 51 adapted to lock the ladder 11 in a storage position.

In this ladder unit for climbing up and down a construction machine, the ladder 11 can be locked in a storage position as well, so that the unexpected projection of the ladder 11 during an operation of the construction machine can be prevented. This enables the inconvenience of occurrence of the breakage of the ladder, which is ascribed to the unexpected outward projection of the ladder 11 and the interference thereof with surrounding parts, to be eliminated.

According to a further aspect of the present invention, the ladder unit for climbing up and down a construction machine has a balance weight 15 adapted to slide the ladder 11 to a storage position, and an urging device 41 adapted to urge the ladder 11 toward a position of descent thereof when the ladder 11 is locked in the storage position.

In this ladder unit for climbing up and down a construction machine, the ladder 11 is moved forcibly toward the position of descent thereof by the urging device 41 when the ladder is unlocked in the storage position. This enables the unlocking of the ladder to be done reliably, and a later operation for pulling down the ladder 11 to be carried out easily and smoothly.

According to another aspect of the present invention, the ladder unit for climbing up and down a construction machine has a detector 44 adapted to detect an unlocked condition of the ladder 11 in a position of storage thereof, and a device for stopping a movement of the construction machine when the ladder is released from a locking force.

In this ladder unit for climbing up and down a construction machine, the stopping of a movement of the construction machine, for example, the stopping of the travel of a lower traveling unit 1 of a hydraulic excavator and a swinging movement of an upper body 2 thereof is carried out when the ladder 11 is not locked in the storage position. Accordingly, accidents, such as the breakage of the ladder unit can be prevented.

According to still another aspect of the present invention, the ladder unit for climbing up and down a construction machine has a guide 10 provided on a body frame 5, and a ladder 11 supported longitudinally slidably on the guide 10 and adapted to be moved up and down between a storage position in which the ladder is stored and a position of descent to which the ladder is lowered when the ladder is practically used, the ladder being provided so as not to project outward from a side surface of the construction machine when the ladder is in the storage position.

In this ladder unit for climbing up and down a construction machine, the ladder 11 is provided so as not to project outward from a side surface of a construction machine when the ladder 11 is in a storage position. Therefore, the inconvenience of encountering the breakage of the ladder 11 in the case of a related art outwardly projecting ladder due to the interference of the same with surrounding parts can be eliminated.

### BRIEF DESCRIPTION OF THE DRAWINGS

A preferred embodiment of the present invention will be described in detail with reference to the following figures, wherein:

FIG. 1 is a front view of a hydraulic excavator as a mode of example of a construction machine provided with a ladder unit for climbing up and down the construction machine;

FIG. 2 is a rear view of this hydraulic excavator;

FIG. 3 is a plan view of the same hydraulic excavator;

FIG. 4 illustrates a mode of embodiment of the ladder unit for climbing up and down a construction machine according to the present invention, wherein:

FIG. 4(a) is a sectional view of the mode of embodiment with a ladder in a storage position thereof; and

FIG. 4(b) is a sectional view of the mode of embodiment with the ladder in a position of descent thereof;

FIG. 5 is an enlarged view showing a principal portion of a mechanism for locking the ladder in a position of storage thereof in the same mode of embodiment;

FIG. 6 is an enlarged view showing a principal portion of a mechanism for locking the ladder in a position of descent thereof in the same mode of embodiment;

FIG. 7 is an enlarged view of a principal portion showing a support structure for a locking rod in the same mode of embodiment;

FIG. 8 is a sectional view showing a support structure for the ladder on a guide in the same mode of embodiment;

FIG. 9 is a sectional view showing a support structure for a balance weight in the guide in the same mode of embodiment;

FIG. 10 is a sectional view for describing an urging device provided on an upper portion of the guide in the same mode of embodiment; and

FIG. 11 is an illustration for describing a detector provided on the guide and ladder in the same mode of embodiment.

### DESCRIPTION OF THE PREFERRED EMBODIMENT

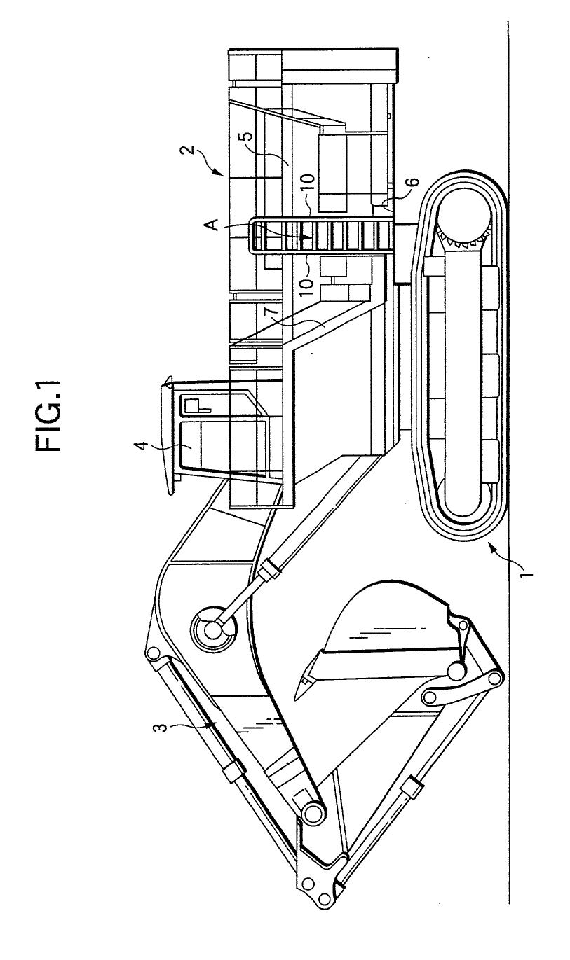

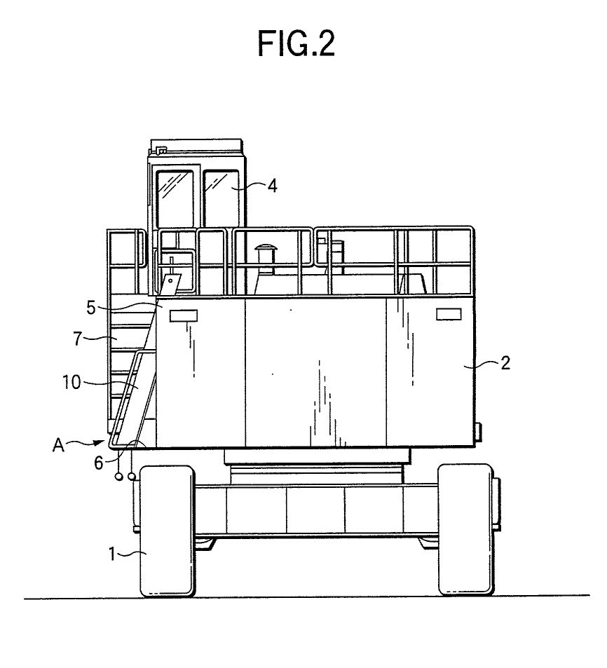

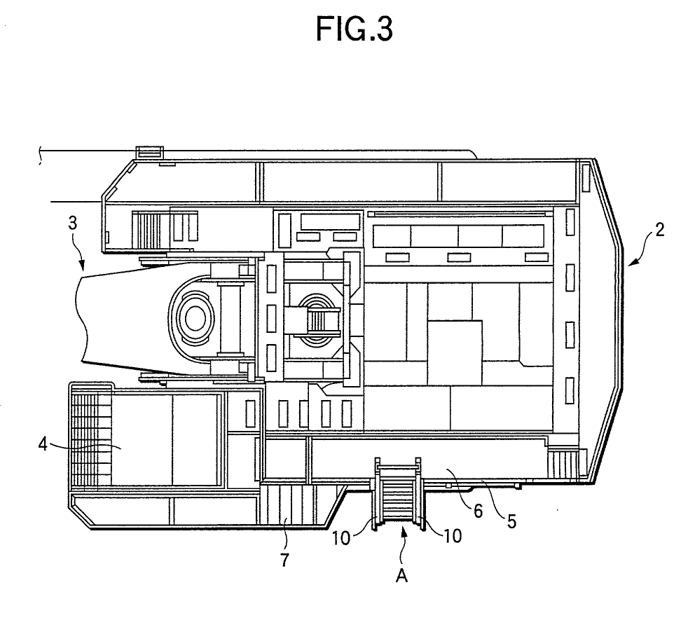

A concrete mode of embodiment of the ladder unit for climbing up and down a construction machine according to the present invention will now be described in detail with reference to the drawings. FIG. 1 is a front view of a hydraulic excavator as a mode of example of a construction machine, FIG. 2 a rear view of the same hydraulic excavator, and FIG. 3 a plan view of the same.

The hydraulic excavator in this mode of embodiment is provided with a lower traveling unit 1, an upper body 2 supported swingably on the lower traveling unit 1, and a working machine 3 including a boom fixed pivotably to the upper body 2, an arm and a bucket, a cabin 4 being provided on the upper body 2. At a side portion of the upper body 2, a ladder unit A for climbing up and down a construction machine is fixed to the body frame 5. This ladder unit A is utilized when an operator on the ground pulls down a ladder 11 to a position of descent thereof, climbs up the ladder onto a catwalk 6 of the upper body 2, and gets on the cabin 4 via a stairway 7. The ladder unit is also utilized similarly when the operator conversely climbs down the construction machine.

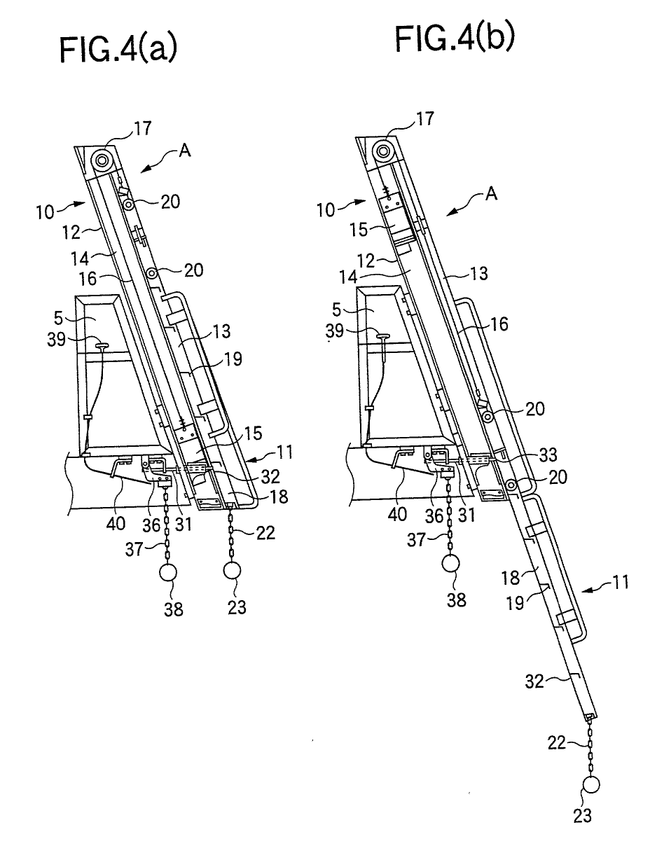

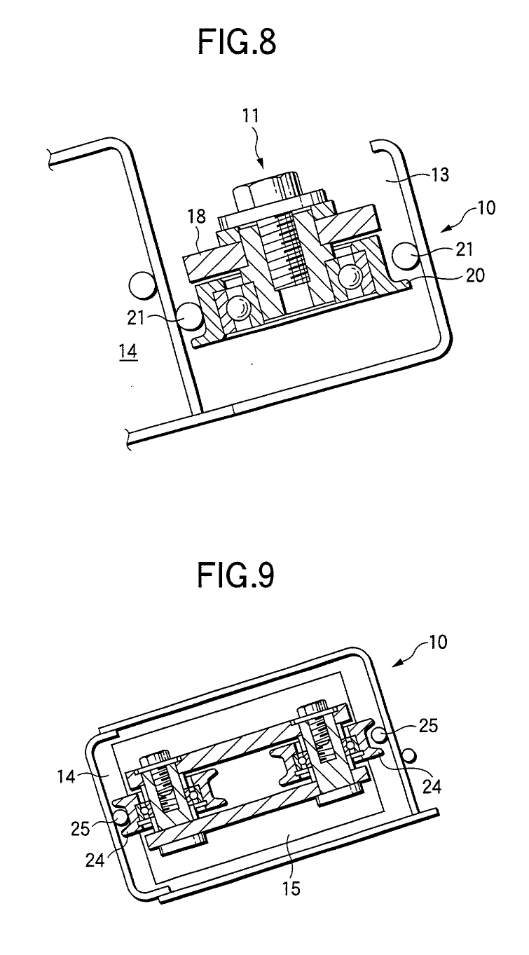

The outline of the construction of the ladder unit A for climbing up and down a construction machine will be described on the basis of FIG. 4. This ladder unit A is provided with a guide 10 fixed to the body frame 2, and the ladder 11 supported slidably on the guide 10. FIG. 4A is a sectional view of the ladder 11 in a storage position in which the ladder is stored in the guide 10, and FIG. 4B a sectional view of the ladder 11 in a position of descent thereof to which the ladder is drawn out. As shown in FIGS. 1 and 3, the guide 10 has left and right parallel-arranged guide members 12, 12, and each of the guide members 12 extends diagonally downward at an angle of about 150 with respect to the body frame 2 as shown in FIG. 4. Each guide member 12 is provided with a ladder slider 13, and a balance weight slider 14 formed in a position on the rear side of the ladder slider, and the ladder slider is slidably provided with ladder, and the balance weight slider is slidably provided with balance weight. The ladder slider 13 is opened sideways (refer to FIG. 8) so as to hold the slider 11 slidably. The ladder 11 and balance weight 15 are connected together by a rope 16, an intermediate portion of which is passed around a sheave 17 supported via a shaft on a top portion of the guide member 12. The weight of the balance weight 15 is set larger than that of the ladder 11. Therefore, when an external force is not imparted at all to the ladder 11, the ladder is drawn up by the balance weight 15, and placed in the storage position shown in FIG. 4A. When the ladder 11 is put to use, it is pulled down.

The structure of the ladder 11 will now be described. The ladder 11 is a step-connected device having left and right side members 18, 18 (only one of which is shown in FIG. 4), and footsteps 19 provided at predetermined intervals between the side members 18, 18, and the side members 18, 18 are supported slidably in the ladder sliders 13 of the guide 10. As shown in FIGS. 4 and 8, plural guide rollers 20 are provided on the side members 18, 18 so that the guide rollers 20 roll inside the ladder sliders 13. Referring to FIG. 8, a reference numeral 21 denotes guide rails. As shown in FIG. 4, a ring type ladder-lowering handle 23 is fixed to a lower end portion of the ladder 11 via a chain 22.

The structure of the balance weight 15 will be described on the basis of FIG. 9. This balance weight 15 is provided with plural guide rollers 24, which are adapted to roll on both upper and lower surfaces of the balance weight slider 14. These guide rollers 24 are guided by rails 25 provided on both the upper and lower surfaces of the balance weight slider 14.

The characteristic point of the ladder unit for climbing up and down a construction machine resides in the provision of a locking mechanism for stopping a movement of the ladder 11 when the ladder 11 is in use and in a position of descent thereof and when the ladder is not in use and in a storage position. This locking mechanism has a locking rod 3l supported retractably on a lower portion of the guide 10 of the body frame 5, a stored ladder locking member 32 fixed to a lower portion of a rear surface of the ladder 11, and a lowered ladder locking member 33 fixed to an upper portion of the rear surface of the ladder 11. The locking rod 31 and stored ladder locking member 32 constitute a stored ladder locking mechanism 51, and the locking rod 31 and lowered ladder locking member 33 a lowered ladder locking mechanism 52.

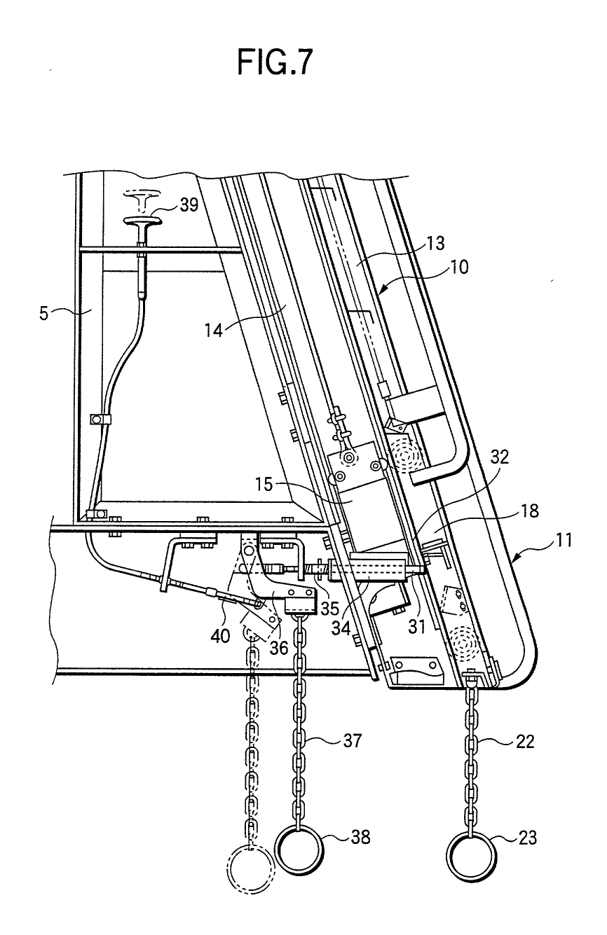

The details of a support structure for the locking rod 31 is shown in FIG. 7. As shown in the drawing, the locking rod 31 is supported slidably on a guide sleeve 34 fixed to the body frame 5. The locking rod 31 is urged by a spring 35 as an urging device so that the locking rod projects toward the ladder 11. In a position on a rear portion of the locking rod 31, an arm 36 is supported pivotably on the body frame 5, and this pivotable arm 36 is pin-connected to a rear end portion of the locking rod 31. Namely, the locking rod 31 is set so that an urging force of the spring 35 enables the locking rod to be moved back away from the ladder 11 against the resilient force of the spring 35. An operating handle 38 is fixed to the pivotable arm 36 via a chain 37, so that the pivotable arm 36 can be turned by pulling down the operating handle 38. Referring to FIG. 7, a reference numeral 39 denotes an operating knob. When a wire 40 joined to this operating knob 39 is connected to the pivotable arm 36 with the operating knob 39 then pulled up, the pivotable arm 36 can also be turned. This operating knob 39 is provided in a position in which the operator climbing up onto the catwalk 6 can operate the same.

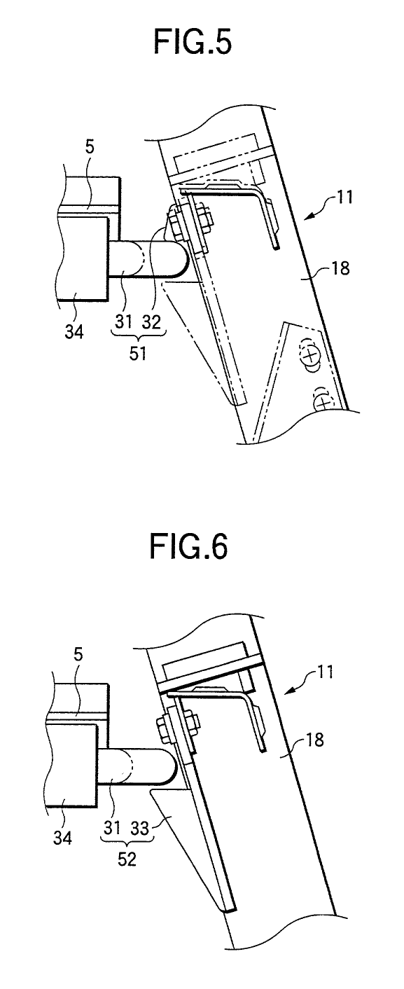

FIG. 7 shows the ladder 11 in a storage position, and the condition of the stored ladder locking mechanism 51 in this case is shown in FIG. 5. As shown in this drawing, the stored ladder locking member 32 provided on the rear surface of the ladder 11 moves up as it presses down the locking rod 31 during an upward movement of the ladder 11 toward the storage position. When the stored ladder locking mechanism which moves up gets beyond a position of the locking rod 31, the locking rod 31 projects, and a lower end surface of the stored ladder locking member 32 engages the locking rod 31 from the upper side of the latter, whereby a downward movement of the ladder 11 is stopped. This stored ladder locking member 32 is tapered at the surface thereof by which the locking rod is pressed down, so as to enable an operation for pressing down the locking rod 31 while the stored ladder locking member 32 moves up and gets beyond the mentioned position to be carried out smoothly.

FIG. 4B shows the ladder 11 in a lower position, and the condition of a lowered ladder locking mechanism 52 in this case is shown in FIG. 6. As shown in this drawing, the lowered ladder locking member 33 is set so that, when the lowered ladder locking member 33 provided on a rear surface of the ladder 11 moves down as it presses down the locking rod 31 while the ladder 11 moves down to a lower position, to get beyond a position of the locking rod 31, the locking rod projects, and an upper end surface of the lowered ladder locking member 33 engages the locking rod 31 from the lower side of the latter to stop an upward movement of the ladder 11. The lowered ladder locking member 33 is tapered at the surface thereof, by which the locking rod 31 is pressed down, more gently than the above-mentioned stored ladder locking member 32 so that an operation for pressing down the locking rod 31 can be carried out smoothly when the lowered ladder locking member 33 moves down as it presses down the locking rod 31, to get beyond the position of the locking rod 31 as mentioned above. The operation of the stored ladder locking member 51 is carried out by the force of the balance weight, while the operation of the lowered ladder locking mechanism 52 is carried out by the operator's force against the force of the balance weight 15. In view of this, the locking rod pressing surface of the lowered ladder locking member is tapered to reduce the force required for the operation of the lowered ladder locking mechanism 52.

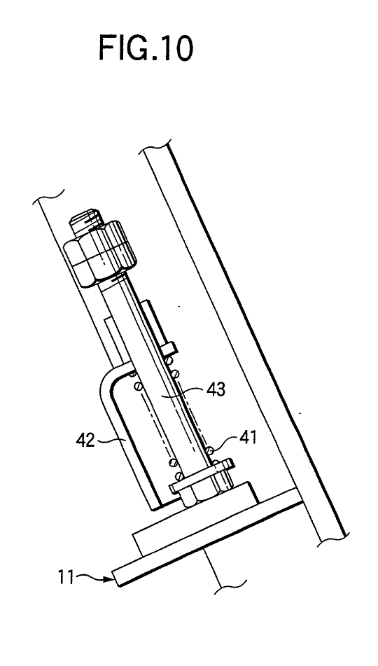

Some other characteristic point of the ladder unit A will be described. This characteristic point resides in the use shown in FIG. 10 of a device, for example, a spring 41 for urging the ladder 11 downward when the ladder 11 is in the storage position shown in FIG. 4A. Namely, a bracket 42 is fixed to an upper portion of the guide 10, and a pressure rod 43 is supported retractably on the bracket 42 and urged by the spring 41 in the direction in which the pressure rod projects outward. When the ladder 11 is in the storage position with the stored ladder locking member 32 engaged with the locking rod 31 as shown in FIG. 5, the pressure rod 43 is raised, and a pressing force works on the ladder 11 downward owing to the spring 41. This structure is provided so as to lower the ladder 11 forcibly by a predetermined distance by the force of the spring 41 when the ladder is released from the locking force of the stored ladder locking mechanism 51, and thereby reliably disengage the stored ladder locking member 32 and locking rod 31 from each other.

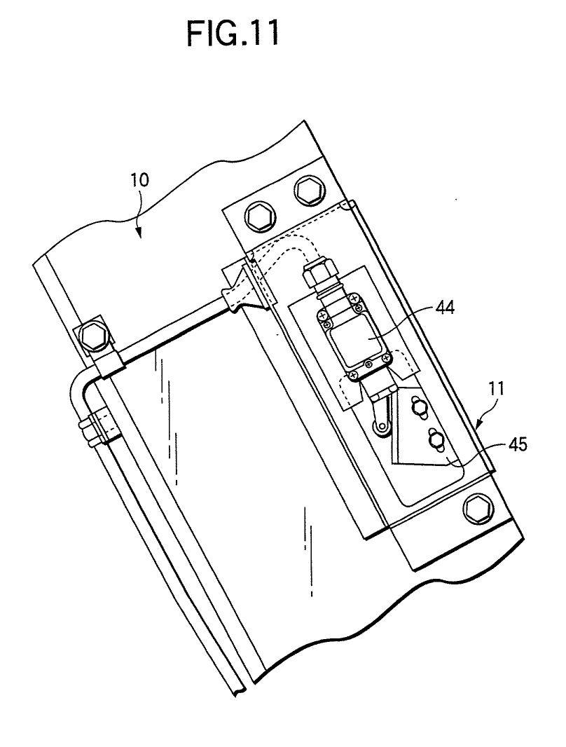

Providing as shown in FIG. 11 a limit switch 44 as a device for detecting the condition of the ladder released from the locking force of the stored ladder locking mechanism 51 also constitute another characteristics of this mode of embodiment. Namely, the limit switch 44 is provided on the guide 10, while a switch 45 for operating this limit switch 44 is fixed to the ladder 11, so as to turn off the limit switch 44 when the ladder is locked by the stored ladder locking mechanism 51, and turn on the limit switch 44 when the ladder is released from the locking force of the stored ladder locking mechanism. The on-off operations of the limit switch 44 are outputted to a controller (not shown). When the limit switch 44 is on, a movement of the lower traveling unit 1 and a swinging movement of the upper body 2 are prohibited, and the disengaged condition of the stored ladder locking mechanism 51 is displayed luminously on a panel inside the cabin 4. Such a structure is provided so as to stop an operation of the construction machine by an operation stopping device (not shown) in the condition in which the locking force of the stored ladder locking mechanism 51 is released from the ladder, and thereby prevent an accident, such as the breakage of the ladder unit A.

The operation of the ladder unit A for climbing up and down a construction machine will now be described. First, when the operator gets on the construction machine, the ladder unit A is in a stored state shown in FIGS. 4A and 7. The operator pulls down the operating handle 38. Consequently, the pivotable arm 36 is turned, and the locking rod 31 is moved in the retracting direction against the force of the spring 35 to cause the ladder to be released from the locking force of the stored ladder locking mechanism 51. During this time, the ladder 11 is pressed down by the urging force of the spring 41 shown in FIG. 10, and moved forcibly by a predetermined distance. This enables the locking force of the stored ladder locking mechanism 51 to be released reliably from the ladder. A ladder lowering handle 23 is then gripped with the mentioned parts left in the same condition, and pulled down. When the ladder 11 is lowered by a predetermined distance, a locking operation of the lowered ladder locking mechanism 52 is carried out automatically, so that the ladder 11 is locked in the position of descent to which the ladder is lowered. The operator then climbs up the ladder 11 onto the catwalk 6.

The operator on the catwalk 6 then pulls up the operating knob 39. Consequently, the pivotable arm 36 is turned, and the locking rod 31 is moved in the retracting direction against the force of the spring 35 to cause the locking force of the lowered ladder locking mechanism 52 to be released from the ladder 11. Consequently, the ladder 11 moves up automatically. After the ladder moves up by a predetermined distance, a locking operation of the stored ladder locking mechanism 51 is now carried out automatically, and the ladder 11 is locked in a ladder storage position. During this time, the spring 41 shown in FIG. 10 is compressed by an inertial force of the ascending ladder 11. The operator then gets on the cabin 4 via the stairways 7.

When the operator gets off the construction machine, he takes a reverse procedure, i.e., he pulls up the operating knob 39 from a position on the catwalk 6 to release the locking force of the stored ladder locking mechanism 51 from the ladder. The lowered ladder locking mechanism 52 is locked automatically by the ladder lowering operation, and the operator then gets off the construction machine by utilizing the ladder 11. The operator thereafter pulls down the operating handle 38 to release the locking force of the lowered ladder locking mechanism 52 from the ladder, and return the ladder automatically to the storage position by the force of the balance weight 15, the ladder being then locked again by the stored ladder locking mechanism 51.

Since the ladder unit A is provided with the mechanism 51 for locking the ladder 11 in the lowered ladder locking position, the movement of the ladder 11 is stopped by the lowered ladder locking mechanism 52 in the position to which the ladder is pulled down. Therefore, the ladder 11 is stabilized in this position of descent thereof, so that the operator's actions to climb up and down the construction machine can be made smoothly.

The operator can also release the locking force of the locking mechanism 52 from the ladder from a position on the catwalk 6. This enables an operation for storing the ladder 11 in the storage position to be carried out easily. Namely, since the ladder 11 is set so as to be returned naturally to the storage position, the ladder 11 returns naturally as it is to the storage position by such an unlocking operation. Consequently, the degree of convenience of use of the ladder unit is improved.

Since the mechanism 51 for locking the ladder 11 in the storage position is further provided so that the ladder 11 can be locked in the storage position as well, the occurrence of unexpected projection of the ladder 11 during an operation of the ladder unit can be prevented. This can prevent the ladder 11 from encountering its unexpected projection, and its interfering with a surrounding part to be broken.

Since a spring is provided as a device 41 for urging when the ladder 11 is locked in the storage position thereof the ladder 11 toward a position of descent thereof, a forcible downward driving force occurs, when the ladder 11 is released from the locking force in the storage position thereof, in the ladder 11 due to the force of the urging device 41, whereby the releasing of the locking force from the ladder can be done reliably. Accordingly, a subsequent ladder lowering operation can be carried out easily and smoothly. When such an urging device 41 is not provided, it is necessary to carry out a ladder lowering operation by gripping the ladder lowering handle 23 with the operating handle 38 in a pulled-down state. However, when the urging device 41 is provided, the ladder lowering operation can be carried out by gripping the ladder lowering handle 23 with the operator's hand released from the operating handle 38.

Furthermore, the ladder unit A is provided with the limit switch 44 for detecting a locking force-released condition of the ladder in the position in which the ladder 11 is stored, and a device for stopping an operation of the construction machine when the locking force is released from the ladder. Therefore, when the ladder 11 is not locked in the storage position, movement stopping operations, such as an operation for stopping the movement of the lower traveling unit 1 and an operation for stopping the swinging movement of the upper body 2 are carried out. This enables the occurrence of accidents, such as the breakage of the ladder unit A to be prevented.

Still other characteristics of the mode of embodiment of the ladder unit A will now be described. The characteristics reside in the ladder 11 provided so that the ladder 11 does not project beyond a side surface of the construction machine when the ladder is in the storage position. Namely, as is clear from FIGS. 2 and 3, the ladder 11 and ladder unit A as a whole are arranged so that they do not project sideways when the ladder 11 is stored. As shown in the drawings, a part projecting sideways most of the hydraulic excavator in the mode of embodiment is the stairway 7. The width of the hydraulic excavator is determined by the stairway 7, and the ladder 11 and ladder unit A as a whole are arranged so that they do not project outward beyond the outer side surface of the stairway.

Since the ladder 11 is provided so that the ladder in the storage position does not project beyond a side surface of the construction machine, the inconvenience of occurrence of the breakage of the ladder, which is ascribed to the interference of the ladder in a projecting state with the surrounding parts, can be eliminated.

The above is a description of a concrete mode of embodiment of the present invention. The present invention is not limited to this mode of embodiment but can be practiced by modifying the invention in various ways within the scope thereof. For example, in the above-described mode of embodiment, the balance weight 15 is used to return the ladder 11 to the storage position. In order to move the ladder 11 to the storage position or a position of descent, some other driving power source, such as an electric motor, a hydraulic motor or a hydraulic cylinder may be used, and the present invention can also be applied to a ladder not having a driving power source. Although the ladder 11 in the storage position and stored entirely within the guide 10 is illustrated as an example, the stored condition of the ladder is not limited to only such a condition. The storage position referred to in this embodiment means a position in which the ladder is not in use.

Although a hydraulic excavator is shown as a construction machine in the above-described mode of embodiment, the present invention can also be applied in completely the same manner to some other construction machine, such as a crawler crane.

What is claimed is:

1. A ladder unit for climbing up and down a construction machine, comprising a guide provided on a body frame, a ladder supported longitudinally slidably on the guide and moved up and down between a storage position in which the ladder is stored and a position of descent while the ladder is in use, and a mechanism for locking the ladder in the position of descent thereof.

2. A ladder unit for climbing up and down a construction machine according to claim 1, wherein the releasing of the ladder from a locking force of the locking mechanism in a position on the construction machine is rendered possible.

3. A ladder unit for climbing up and down a construction machine according to claim 1, wherein a mechanism for locking the ladder in the storage position thereof is provided.

4. A ladder unit for climbing up and down a construction machine according to claim 2, wherein a mechanism for locking the ladder in the storage position thereof is provided.

5. A ladder unit for climbing up and down a construction machine according to claim 3, wherein a balance weight for sliding the ladder to the storage position thereof, and a device for urging the ladder, which is locked in the storage position thereof, toward the position of descent thereof are provided.

6. A ladder unit for climbing up and down a construction machine according to claim 4, wherein a balance weight for sliding the ladder to the storage position thereof, and a device for urging the ladder, which is locked in the storage position, toward the position of descent thereof are provided.

7. A ladder unit for climbing up and down a construction machine according to claim 3, wherein a detector for detecting an unlocked condition of the ladder in the storage position thereof, and a device for stopping an operation of the construction machine when the ladder is released from a locking force are provided.

8. A ladder unit for climbing up and down a construction machine according to claim 4, wherein a detector for detecting an unlocked condition of the ladder in the storage position thereof, and a device for stopping an operation of the construction machine when the ladder is released from a locking force are provided.

9. A ladder unit for climbing up and down a construction machine according to claim 5, wherein a detector for detecting an unlocked condition of the ladder in the storage position thereof, and a device for stopping an operation of the construction machine when the ladder is released from a locking force are provided.

10. A ladder unit for climbing up and down a construction machine according to claim 6, wherein a detector for detecting an unlocked condition of the ladder in the storage position thereof, and a device for stopping an operation of the construction machine when the ladder is released from a locking force are provided.

11. A ladder unit for climbing up and down a construction machine, comprising a guide provided on a body frame, and a ladder supported longitudinally slidably on the guide and moved up and down between a storage position thereof in which the ladder is stored and a position of descent while the ladder is in use, the ladder being provided so that the ladder in the storage position thereof does not project outward beyond a side surface of the construction machine.
